(19) United States
(12) Patent Application Publication
(10) Pub. No.: US 2024/0150251 A1
(43) Pub. Date: May 9, 2024

(54) REPAIR OF DEFECTS EXTENDING INTO AN UNDERLYING LAYER OF ENVIRONMENTAL BARRIER COATINGS

(71) Applicant: General Electric Company, Schenectady, NY (US)

(72) Inventors: Atanu Saha, Bengaluru (IN); Don Mark Lipkin, Niskayuna, NY (US); Sreerama Prasad R, Bengaluru (IN); Mamatha Nagesh, Bengaluru (IN); Nicholas Edward Antolino, Schenectady, NY (US)

(21) Appl. No.: 17/979,866

(22) Filed: Nov. 3, 2022

(51) Int. Cl. C04B 41/52; C04B 41/00; C04B 41/45; C04B 41/50; C04B 41/87; C04B 41/89

(52) U.S. Cl. CPC C04B 41/522; C04B 41/0072; C04B 41/009; C04B 41/4539; C04B 41/5024; C04B 41/5096; C04B 41/87; C04B 41/89

(57) ABSTRACT

Methods for repairing a defect in a multilayered coating on a silicon-containing substrate are provided, along with the resulting compared component. The method includes: applying a first patch slurry into the defect; drying the first patch slurry to form a dried first patch layer; applying a second patch slurry into the defect and on the dried first patch layer; and drying the second patch slurry to form a second dried patch layer.

### FIELD

The present disclosure relates to repair of multilayered coatings, such as multilayered coatings on a silicon-containing substrate.

### BACKGROUND

Silicon-based materials are employed for high temperature components of gas turbine engines such as, for instance, airfoils (e.g., blades, vanes), combustor liners, and shrouds. The silicon-based materials may include silicon-based monolithic ceramic materials, intermetallic materials, and composites. For example, silicon-based ceramic matrix composites (CMCs) may include silicon-containing fibers reinforcing a silicon-containing matrix phase.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1A is a schematic cross-sectional view of a component having defects extending through its environmental barrier coating and into its underlying bond coat;

FIG. 1B is a schematic cross-sectional view of a component having defects extending through its environmental barrier coating, through its underlying bond, and into the underlying substrate;

FIG. 2A is a schematic cross-sectional view of a component having one or more damaged locations in which a first patch layer has been applied into the defects of the component in FIG. 1A;

FIG. 2B is a schematic cross-sectional view of a component having one or more damaged locations in which a first patch layer has been applied into the defects of the component in FIG. 1B;

FIG. 3A is a schematic cross-sectional view of a component having one or more damaged locations in which a second patch layer has been applied into the defects of the component in FIG. 2A;

FIG. 3B is a schematic cross-sectional view of a component having one or more damaged locations in which a second patch layer has been applied into the defects of the component in FIG. 2B;

FIG. 4A is a schematic cross-sectional view of a component having one or more damaged locations in which the first patch layer and the second patch layer has been sintered within the defects to form a multilayer patch within the defects of the component in FIG. 3A;

FIG. 4B is a schematic cross-sectional view of a component having one or more damaged locations in which the first patch layer and the second patch layer has been sintered within the defects to form a multilayer patch within the defects of the component in FIG. 3B; and

FIG. 5 is a diagram of an exemplary method of one embodiment for repairing a component having a defect(s) extending through its environmental barrier coating and into its underlying bond coat and/or underlying substrate.

### DEFINITIONS

To describe and point out the subject matter more clearly and concisely, the following definitions are provided for specific terms used throughout the following description and the appended claims, unless specifically denoted otherwise.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

The term “defect” as used herein refers to a portion of the protective layers and/or substrate exposed to the environment due to damage.

The term “slurry” as used herein refers to a mixture of at least one solid constituent with at least one liquid constituent.

The term “sintering aid” as used herein refers to a material that decreases the sintering temperature of the dried patch material and/or enhances sintering kinetics of the dried patch material at a particular sintering temperature.

The term “viscosity modifier” refers to a material that alters rheology of the slurry as a function of applied stress and/or shear rate during deposition of the slurry.

An “oxidizing atmosphere” is an atmosphere that contains sufficient oxygen partial pressure to cause an oxidation reaction and may include air and combustion gas.

As used herein, the term “silicon-containing substrate” is a substrate that includes silicon, a silicon alloy, a compound having silicon and at least one other element, or a combination of silicon alloy and the compound having silicon and the at least one other element. As used herein in the context of silicon-containing powders, the terms “silicon” and “silicon-based alloy” refer to their respective unoxidized forms.

As used herein, ceramic-matrix-composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃·2SiO₂), as well as glassy aluminosilicates.

In embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine components used in higher temperature sections of gas turbine engines, such as airfoils (e.g., turbines, and vanes), combustors, shrouds and other like components, that would benefit from the lighter-weight and higher temperature capability these materials can offer.

As used herein, an environmental-barrier-coating (“EBC”) refers to a coating system comprising one or more layers of ceramic materials, each of which provides specific or multi-functional protections to the underlying CMC. EBCs generally include a plurality of layers, such as rare earth silicate coatings (e.g., rare earth disilicates such as slurry or APS-deposited yttrium ytterbium disilicate (YbYDS)), alkaline earth aluminosilicates (e.g., comprising barium-strontium-aluminum silicate (BSAS), such as having a range of BaO, SrO, Al₂O₃, and/or SiO₂ compositions), hermetic layers (e.g., a rare earth disilicate), and/or outer coatings (e.g., comprising a rare earth monosilicate, such as slurry or APS-deposited yttrium monosilicate (YMS)). One or more layers may be doped as desired, and the EBC may also be coated with an abradable coating.

As used herein, “Ln” refers to a rare earth element or a mixture of rare earth elements. More specifically, the “Ln” refers to the rare earth elements of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), or mixtures thereof.

As used herein, the term “substantially free” is understood to mean completely free of said constituent, or inclusive of trace amounts of same. “Trace amounts” are those quantitative levels of chemical constituent that are barely detectable and provide no benefit to the functional or aesthetic properties of the subject composition. The term “substantially free” also encompasses completely free.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

Although silicon-containing substrates exhibit desirable high temperature characteristics, such substrates can suffer from rapid recession in combustion environments. For example, silicon-containing substrates are susceptible to volatilization upon high-temperature exposure to reactive species such as water vapor. In such cases, coatings are used to protect the silicon-containing substrates. Silicon-containing substrates, such as CMCs, may have multiple protective coating layers on its surface, such as a silicon bond coat and di-silicate and/or mono-silicate EBCs. These protective layers help to prevent the degradation of silicon-containing substrates in a corrosive water-containing environment by inhibiting the ingress of water vapor and the subsequent formation of volatile products such as silicon hydroxide (e.g., Si(OH)₄). Several additional layers, such as an abradable layer, may also be deposited on the EBC to provide specific functionality to CMC components. Thus, the protective layers may enhance the high temperature environmental stability of silicon-containing substrates. Other desired properties for the EBC include a thermal expansion compatibility with the silicon-containing substrate, low permeability for oxidants, low thermal conductivity, and chemical compatibility with the thermally grown silicon-based oxide.

During service, one or more of these protective layers may suffer some from damage, such as in the form of a defect. If an EBC experiences a localized spall or a pinhole defect, the underlying substrate may be subject to material loss resulting from water vapor-induced volatilization and subsequent surface recession during operation. If allowed to grow unmitigated, such material loss may reduce the load-bearing capability of the component, disrupt airflow, or even progress to through-thickness holes, which may adversely affect the operating performance and durability of the machine. A process to locally patch repair each of the missing protective layers and the underlying material of the silicon-containing substrate is therefore desired.

Methods are generally described herein for repairing a defect in a multilayered coating on a silicon-containing substrate that results in a patch that more closely matches the structure and function of the original materials prior to damage, especially compared to previous methods employing a single patch material. Advantageously, the use of the two or more patch slurries as described herein allows for the production of a multilayered patch with layers that are configured to correlate with the respective material of the original composition. Moreover, these patch slurries can be used to repair defects on the silicon-containing substrate in situ, thus minimizing or eliminating the need to disassemble the machine, such as a turbine engine, as would be required for conventional component repairs. Thus, defects on a silicon-containing substrate and its coatings can be repaired in a more timely and cost effective manner as compared to other processes.

Damaged areas of a repair region can include damage to any of the protective layers and/or the silicon-containing substrate. Accordingly, the slurries provided herein may be applied to the damaged areas of the component and may facilitate repair of the EBC, other protective layers present, and the silicon-containing substrate. The composition of each patch material in the individual patch slurries may be independently selected to correlate with the material of the layer of the multilayered coating and/or substrate that it replaces in the defect. As used here, the term “correlates” means that the patch material will, upon drying and sintering, effectively replace the material and function of the layer of the multilayered coating and/or substrate in the defect.

Accordingly, embodiments of this disclosure recite a method for forming a sintered patch on a silicon-containing substrate. Thus, the multilayered patch can be formed on two or more of the afore-mentioned layers including layer(s) of the EBC, a thermally grown oxide layer, a bond coat, and/or the silicon-containing substrate itself.

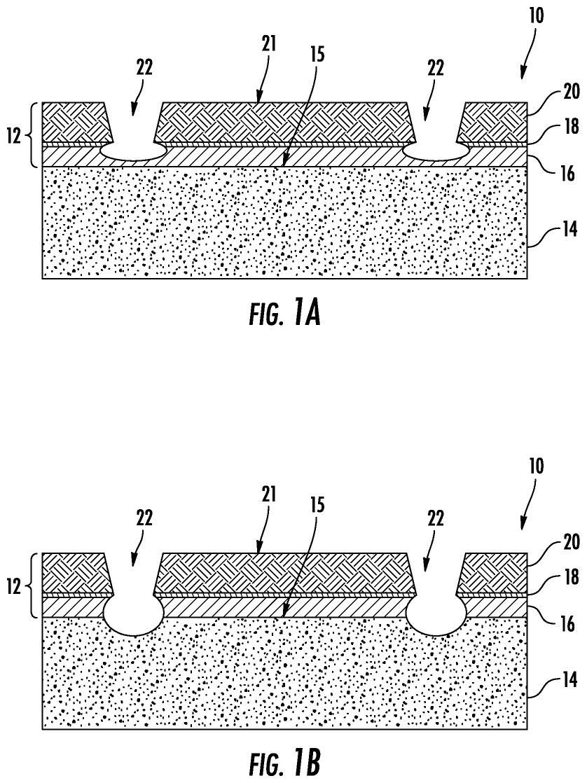

FIGS. 1A and 1B are cross-sectional views of a component 10 for use in a high temperature environment of a gas turbine engine, such as a blade, a vane, a combustor liner, a shroud, etc. In FIGS. 1A and 1B, the component 10 includes a multilayered coating 12 on a surface 15 of a silicon-containing substrate 14. In the embodiment shown, a bond coat 16 is present on the surface 15 of the silicon-containing substrate 14, and a thermally grown oxide layer 18 (TGO layer 18) is present over the bond coat 16. For example, the thermally grown oxide layer 18 may include silica, particularly when the bond coat 16 comprises silicon. An EBC 20 is present over the thermally grown oxide layer 18.

The silicon-containing substrate 14 may be selected for its high temperature mechanical, physical, and/or chemical properties. The silicon-containing substrate 14 may include any silicon-containing material, such as a silicon-based ceramic material. In a particular embodiment, the silicon-containing substrate 14 includes a silicon-based CMC, such as a silicon carbide containing matrix reinforced with fibers (e.g., silicon carbide). In another example, the silicon-containing substrate 14 may be a silicon-based monolithic ceramic material, for instance silicon carbide (SiC), silicon nitride (Si₃N₄) or a combination of SiC and Si₃N₄. In embodiments, the silicon-containing substrate 14 may be fabricated from a material that can withstand combustion environments at operating temperatures greater than 1150° C. for a duration exceeding 20,000 hours.

In embodiments, the bond coat 16 includes elemental silicon, a silicon alloy, a metal silicide, or a combination thereof. The bond coat 16 generally serves as a chemical barrier, preventing oxidation of the silicon-containing substrate 14 by forming a protective thermally grown silicon oxide layer 18 thereon. Additionally, the bond coat 16 may generally promote the adhesion between the substrate 14 and the EBC 20 by helping to bridge any mismatch between the CTE of the relative materials. The bond coat 16 may have a thickness in a range from 25 micrometers (microns, μm) to 150 μm. In embodiments, the thermally grown oxide layer 18 may have an initial (as-formed) thickness in a range from 1 μm to 10 μm. The thickness of the thermally grown oxide layer 18 may further increase due to the oxidation of the underlying bond coat 16 during use.

The EBC 20 may provide a thermal barrier as well as a hermetic seal against the corrosive gases in the hot combustion environment, and thus protect the underlying thermally grown oxide layer 18, bond coat 16, and silicon-containing substrate 14 from overheating and/or thermochemical attack. By way of example, as described above, the protective coatings present over silicon-containing substrate 14 advantageously facilitate inhibition of oxidation, overheating, and/or volatilization of the silicon-containing substrate material in a hot combustion environment of a gas turbine engine.

The EBC 20 may be a single layer or may include two or more layers. No matter the particular configuration, the EBC 20 may have a total thickness of 25 μm to 1000 μm on the bond coat 16. In embodiments, the EBC 20 may comprise one or more rare earth (Ln) silicates. In embodiments, the silicate of the Ln element may include, but is not limited to, a rare earth monosilicate (Ln₂SiO₅), a rare earth disilicate (Ln₂Si₂O₇), or a combination of Ln₂SiO₅ and Ln₂Si₂O₇. In embodiments, the Ln element in the Ln silicate may include at least one of yttrium, scandium, and elements of the lanthanide series. By way of example, the Ln elements may include yttrium, ytterbium, or lutetium in particular embodiments.

Optionally, one or more additional coatings may be located above or below the EBC 20. Such additional coatings may provide additional functions to the component 10, such as further thermal barrier protection, recession resistance, abradable sealing, thermochemical resistance to corrosion, resistance to erosion, resistance to impact damage, and/or resistance to inter-diffusion between adjacent layers. In embodiments, the EBC 20 and the optional one or more layers may have a coefficient of thermal expansion that is substantially close to a coefficient of thermal expansion of the silicon-containing substrate 14.

Generally, the component 10 of FIGS. 1A and 1B has a defect 22 extending from its outer surface 21, as described in greater detail below. Depending on the severity of the damage to the component 10, material loss may be accompanied in use by recession in the EBC 20, in the thermally grown oxide layer 18, the bond coat 16, and/or the silicon-containing substrate 14 itself.

Referring to FIG. 1A, a defect 22 extends through the EBC 20 and into the bond coat 16. Referring to FIG. 1B, a defect 22 extends through the EBC 20, through the bond coat 16, and into the silicon-containing substrate 14. In one embodiment, the method may include determining that the defect 22 extends into the bond coat 16 and/or into the silicon-containing substrate 14. Such a determination may be performed by visual inspection of the defect, depth measurement of the defect, compositional analysis of the defect, or other suitable methods. For instance, if a silicon-based material is detected, it can be determined that the defect 22 extends into the bond coat 16 (FIG. 1A) and/or into the silicon-containing substrate 14 (FIG. 1B), since both materials are silicon-based.

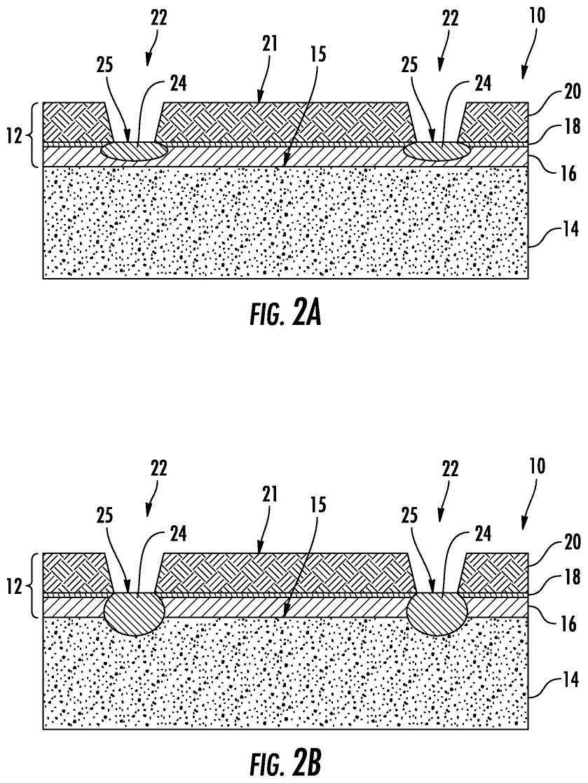

Generally, the method includes applying a first patch slurry into the defect 32 as shown in FIGS. 2A and 2B. The first patch slurry includes a first patch material suspended in a liquid carrier (e.g., a water-based carrier). The first patch material may be formulated to correlate with the material of the deepest layer exposed by the defect 22 (e.g., the bond coat 16 and/or the substrate 14). Generally, the first patch slurry may be applied into the defect 22 in an amount sufficient to substantially fill the defect 22 up to the outermost region of the TGO layer 18, the bond coat 16, and/or into the silicon-containing substrate 14.

Since each of the TGO layer 18, the bond coat 16, and the substrate 14 includes silicon, the first patch material includes a silicon-containing material such that the first patch material correlates with the composition of the TGO layer 18, the bond coat 16, and the substrate 14. In embodiments, the first patch material includes a silicon-containing powder. For example, the silicon-containing material may be a silicon-containing powder. For instance, suitable silicon-containing powders can include elemental silicon, a silicon alloy, a metal silicide, or a combination thereof. In embodiments, the silicon alloy includes boron. In embodiments, the silicon alloy is an alloy of silicon and boron. Without wishing to be bound by any particular theory, it is believed that boron may help to prevent crystallization within the TGO layer 18. In embodiments, the silicon alloy may include alloying elements such as germanium, aluminum, nitrogen, phosphorous, iron, or a combination thereof, as desired to control desired properties of the bond coat 16. In embodiments, the first patch material (in particular, the silicon-containing powder) has a relatively low amount of carbon and/or nitrogen (e.g., less than 0.5 wt. % or substantially free from carbon and/or nitrogen) so as to avoid reaction with the silicon-based material of the bond coat 16, reaction with the substrate 14, and/or oxidation during use.

In embodiments, it may be desired to use silicon-containing powder comprising small particles. A known challenge in using a slurry having predominately small-sized particles is the occurrence of excessive sintering shrinkage and subsequent cracking. In order to compensate for such shrinkage, elemental silicon, silicon alloy(s), and/or metal silicide, can be combined with the silicon-containing powder in the slurry such that a thicker sintered patch can be achieved. For instance, during sintering in an oxidizing atmosphere, the elemental silicon, silicon alloy(s), or metal silicide undergo oxidation to compensate for shrinkage experienced by the silicon-containing powders due to sintering.

In one embodiment, the silicon-containing powder has a multimodal size distribution. Multimodal distribution of particles improves packing density by filling voids created by larger particles with finer particles. Larger particles provide a shrinkage-resistant backbone to the patch and medium particles act as filler, while finer particles promote sintering and bonding to adjacent particles and the silicon-containing substrate. Multimodal distribution of the particles thus helps minimize patch shrinkage (during drying and/or sintering), mitigating cracking and delamination, therefore enabling thicker patches. For example, the silicon-containing powder may include a plurality of small particles having a median particle size of less than 1 μm, a plurality of medium particles having a median particle size from 1 μm to 8 μm; and a plurality of large particles having a median particle size of greater than 8 μm. In such an embodiment, the plurality of small particles may be present in an amount of 10 volume % to 50 volume % of the total volume of the silicon-containing material, the plurality of medium particles may be present in an amount of 10 volume % to 50 volume % of the total volume of the silicon-containing material, and the plurality of large particles may be present in an amount of 20 volume % to 60 volume % (e.g., 30 volume % to 50 volume %) of the total volume of the silicon-containing material.

Other components may be present in the first patch slurry, including but not limited to, a binder, a viscosity modifying agent, a sintering aid, etc., or a combination thereof, as discussed in greater detail below.

Referring to FIGS. 2A and 2B, the first patch slurry may be dried to remove the liquid carrier within the defect 22 to form a dried first patch layer 24 from the first patch material. In embodiments, drying may be performed by heating the first patch slurry within the defect 22, such as subjecting the first patch slurry to a first drying temperature of 50° C. to 250° C. for a period sufficient to remove the liquid carrier (e.g., 20 minutes to 24 hours). Alternatively, the first patch slurry may be dried through evaporation of the liquid carrier at room temperature.

After drying, the dried first patch layer 24 may substantially fill the defect 22 to any extent to which it is within the TGO layer 18, the bond coat 16, and/or into the silicon-containing substrate 14. Thus, the dried first patch layer 24 may form a first surface 25 that substantially corresponds to outermost region of the bond coat 16 and any TGO layer 18 thereon.

Generally, the method also includes applying a second patch slurry into the defect 32 and onto the first surface 25 of the dried first patch layer 24. The second patch slurry includes a second patch material suspended in a liquid carrier (e.g., a water-based carrier). The second patch material may correlate with the material of the EBC 20 exposed by the defect 22 (e.g., the bond coat 16 and/or the substrate 14). Generally, the second patch slurry may be applied into the defect 22 in an amount sufficient to substantially fill the defect 22 on the first surface 15 to the outer surface 21 of the EBC 20.

Generally, the second patch material correlates with the material of the EBC 20. For example, when the EBC 20 includes a silicate-based material, then the second patch material may include a silicate-based material. For example, the silicate-based material may be in the form of a silicate-containing powder, such as a rare earth element silicate powder. The silicate-containing powder may include at least one of a rare earth monosilicate (Ln₂SiO₅) or a rare earth disilicate (Ln₂Si₂O₇), such as Yb₂Si₂O₇. Suitable non-limiting examples also include zirconium silicate (ZrSiO₄), hafnium silicate (HfSiO₄), aluminum silicate (e.g., 3:2 mullite, having a chemical formula Al₆Si₂O₁₃), and combinations thereof. Such materials may serve as an environmental barrier, as well as correlating with the material of the EBC 20. In one embodiment, the rare earth element silicate powder includes a rare earth element having a cation radius of less than 0.95 Angstroms.

The silicate-containing powder may also include silica (SiO₂) and/or boron. In embodiments, the patch material contains sufficient silica to form a silica-rich or borosilicate-rich glass during sintering. For example, the sintered patch can include silica-rich or borosilicate-rich glass after being sintered. In embodiments, the molar ratio of silica to the total silicate is less than 0.2.

In such embodiments, particle size distribution of the silicate-containing powder used in each patch material may be important in determining the mechanical integrity, porosity, and processability of the disposed coating. In embodiments, the silicate-containing powder includes a plurality of small particles with median particle size less than 1 μm. The median particle size of powders is measured as median diameter by volume. The median diameter by volume may be measured using various methods, such as, for example, laser scattering.

In embodiments, the silicate-containing powder used for forming each patch material includes a bimodal distribution of particles. The silicate-containing powder having a bimodal distribution of particles may include small and medium particles or small and large particles. In embodiments, the silicate-containing powder used for forming each patch material includes a trimodal distribution of particles that includes a distribution of large, medium, and small particles. Multimodal distribution of particles improves packing density by filling voids created by larger particles with finer particles. Larger particles provide a shrinkage-resistant backbone to the patch and medium particles act as filler, while finer particles promote sintering and bonding to adjacent particles and the silicon-containing substrate. Multimodal distribution of the particles thus helps minimize patch shrinkage (during drying and/or sintering), mitigating cracking and delamination, therefore enabling thicker patches.

Appropriate selection and control of size and volume fractions of the large, medium, and small particles of the silicate-containing powder may aid in providing the EBCs with the desired properties for a particular application. For example, the silicate-containing powder may include a plurality of small particles having a median particle size of less than 1 μm, a plurality of medium particles having a median particle size from 1 μm to 8 μm; and a plurality of large particles having a median particle size of greater than 8 μm. In such an embodiment, the plurality of small particles may be present in an amount of 10 volume % to 50 volume % of the total volume of the silicate-containing material, the plurality of medium particles may be present in an amount of 10 volume % to 50 volume % of the total volume of the silicate-containing material, and the plurality of large particles may be present in an amount of 20 volume % to 60 volume % (e.g., 30 volume % to 50 volume %) of the total volume of the silicate-containing material.

As with the first patch slurry, other components may be present in the second patch slurry, including but not limited to, a binder, a viscosity modifying agent, a sintering aid, etc., or a combination thereof

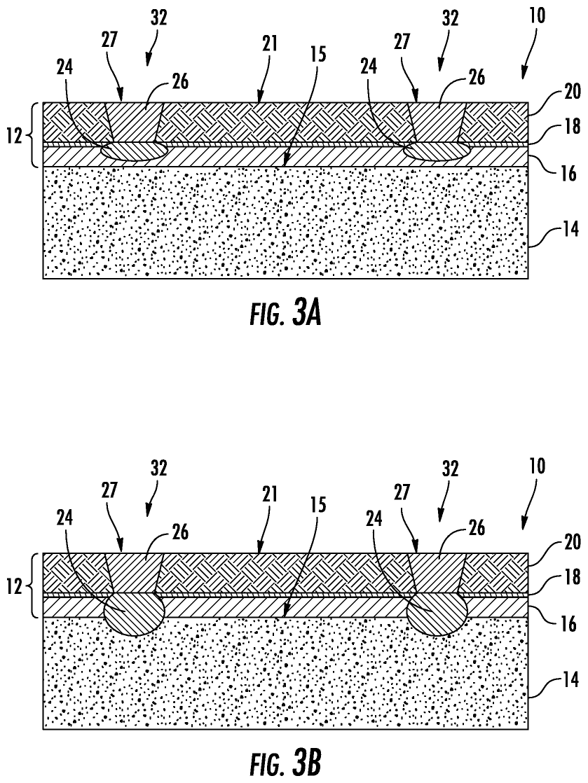

Referring to FIGS. 3A and 3B, the first patch slurry may be dried to remove the liquid carrier within the defect 22 to form a dried second patch layer 26 from the second patch material. In embodiments, drying may be performed by heating the second patch slurry within the defect 22, such as at a second drying temperature of 50° C. to 250° C. Alternatively, the second patch slurry may be dried through evaporation of the liquid carrier at room temperature.

After drying, the dried second patch layer 26 may substantially fill the defect 22 to extend to the outer surface 21 of the EBC 20. Thus, the dried second patch layer 26 may form an outer patch surface 27 that substantially corresponds to outer surface 21 of the EBC 20.

Additional slurry applications and respective drying may be sequentially preformed to produce additional dried patch layers as required to repair additional layers exposed by the defect. For example, a third slurry may be applied and dried to form a third dried patch layer correlating to the next deepest layer exposed by the defect, etc.

In each slurry described above, the binder may be present to facilitate application of the patch slurry, promote adhesion of the patch slurry to the silicon-containing substrate, and/or improve the green strength of the patch slurry after drying. The binder may be an inorganic binder or an organic binder. In embodiments, the binder is an organic binder primarily composed of elements that volatilize during heat treatment, such as binder burnout or sintering, such that they are not present in the final patch. Non-limiting examples of such binders include monoethylene glycol, diethylene glycol, triethylene glycol, tetraethylene glycol, glycerol, polyethylene glycol (PEG), dibutyl phthalate, bis(2-ethylhexyl) phthalate, bis(n-butyl) phthalate, butyl benzyl phthalate, diisodecyl phthalate, di-n-octyl phthalate, diisooctyl phthalate, diethyl phthalate, diisobutyl phthalate, di-n-hexyl phthalate, di(propylene glycol) dibenzoate, di(ethylene glycol) dibenzoate, tri(ethylene glycol) dibenzoate, polyvinyl pyrrolidone (PVP), or any combinations thereof. In embodiments, the binder is PVP.

In embodiments, the binder may include a silicon-containing resin material. For example, when applying to correlate to the EBC, the slurry composition may include a binder of a silicon-containing resin material such as, for instance, a cross-linked polyorganosiloxane resin.

In embodiments, the patch slurries may include a viscosity modifier. Suitable viscosity modifiers may include polyethylene glycol (PEG), dimethylsiloxane, silicone oil, phthalates, adipates, glycerin, or combinations thereof. The viscosity modifier may be present in an amount from 0.05 weight % to 0.7 weight % of the patch material.

As stated, various compositions and amounts of sintering aids may be used in the patch slurries, when present. In embodiments, the sintering aid may include metallic oxides. Non-limiting examples of metallic oxides that can be used as sintering aid include iron oxide, gallium oxide, manganese oxide, aluminum oxide, nickel oxide, titanium oxide, boron oxide, and alkaline earth oxides. In embodiments, a sintering aid may include a metal. Non-limiting examples of metallic sintering aids include iron, aluminum, boron, and nickel. In an exemplary embodiment, the sintering aid is boron. In embodiments, the boron may at least partially oxidize during sintering and the resulting boron oxide may function as the sintering aid. In embodiments, a sintering aid may include hydroxides, carbonates, oxalates, or any other salts of the above-mentioned metallic elements. In embodiments, a median particle size of the sintering aid used herein is less than 1 μm.

In embodiments, the liquid carrier may partially or fully dissolve the binder, the sintering aid, or a combination thereof. The liquid carrier may be organic or aqueous. Non-limiting examples of suitable organic solvents that can be employed as a liquid carrier include methanol, ethanol, propanol, butanol, pentanol, hexanol, heptanol, octanol, nonanol, decanol, dodecanol, diacetyl alcohol, acetone, methyl isobutyl ketone (MIBK), methyl ethyl ketone (MEK), toluene, heptane, xylene, ether, or combinations thereof. In embodiments, the liquid carrier includes diacetone alcohol. The liquid carrier may further include an additional solvent which, in embodiments, facilitates dissolving of a silicon-based binder. In embodiments, the liquid carrier may include a particular combination of two or more liquids.

The strength, volumetric density, degree of oxidation, and hermeticity of a multilayered patch in the defect 22 may depend on each patch slurry's characteristics and/or processing methods. For example, slurry characteristics can include relative amounts of the patch material and the liquid carrier in the patch slurry, particle size distribution of the patch material constituents, the type of binder, the amount of the binder, the type of sintering aids, the amount of the sintering aids, the type of viscosity modifier, the amount of viscosity modifier or any combination thereof. These properties may further vary depending on the processing methods, such as, for example, the methods used for applying the patch slurries, drying the patch slurries, and/or sintering the dried patch layers.

The relative amounts of patch material and liquid carrier in each patch slurry may affect the consistency and viscosity of the patch slurry, as well as the porosity, adhesion and/or strength of the dried patch layer and the multilayered patch. In embodiments, the patch slurries include the patch material in an amount of 10 volume % to 60 volume %. For example, the first patch slurry may include the first patch material in an amount of 10 volume % to 60 volume % within a liquid carrier, and the second patch slurry may include the second patch material in an amount of 10 volume % to 60 volume % within a liquid carrier.

In embodiments, each patch material includes the binder in an amount from 2 weight % to 9 weight % of the silicate-containing powder. In embodiments, each patch material includes the binder in an amount from 4 weight % to 6 weight % of the silicate-containing powder.

In embodiments, each patch material includes the viscosity modifier in an amount from 0.05 weight % to 0.7 weight % of the patch material.

In embodiments, each patch material may include the sintering aid in an amount from 0.2 weight % to 8 weight % based on the total weight of the silicate-containing powder present in the patch material. In embodiments, each patch material may include the sintering aid in an amount from 0.4 weight % to 2 weight % based on the total weight of the silicate-containing powder present in the patch material.

Each slurry may be formed using conventional techniques of mixing known to those skilled in the art, such as shaking, ball milling, attritor milling, or mechanical mixing. Ultrasonic energy may be simultaneously used along with the above-mentioned mixing methods to help break apart any agglomerated particles that may be present in the patch slurries.

In embodiments, the patch slurries may be disposed in a defect 22 of component 10 to make the various slurry patch layers using any conventional slurry deposition method known to those skilled in the art, including but not limited to, spraying, dipping the component into a slurry bath, painting, rolling, stamping, syringe-dispensing, extruding, spreading or pouring the slurry onto the defect 22 of the silicon-containing substrate.

In embodiments, undamaged areas of the EBC 20 and/or silicon-containing substrate 14 may be masked to prevent deposition of the patch slurries onto the undamaged areas. The patch slurries may optionally be mechanically agitated before disposing on the silicon-containing substrate 14 by any method known to those skilled in the art to affect adequate dispersion of the silicon-containing powder, the binder, and the sintering aid in the slurries and ultimately in the dried patch layers formed after drying the patch slurries.

In embodiments, drying of the patch slurries occurs under ambient conditions through evaporation of the solvent. In embodiments, drying of the patch slurries is carried out under elevated temperatures below the sintering temperature before sintering to form the multilayered patch.

The thickness of the dried patch layers may be controlled either during deposition of the patch slurry or by removing excess slurry material after deposition, before or after drying. In embodiments, the thickness of each dried patch layer may be in a range from 10 μm to 1000 μm.

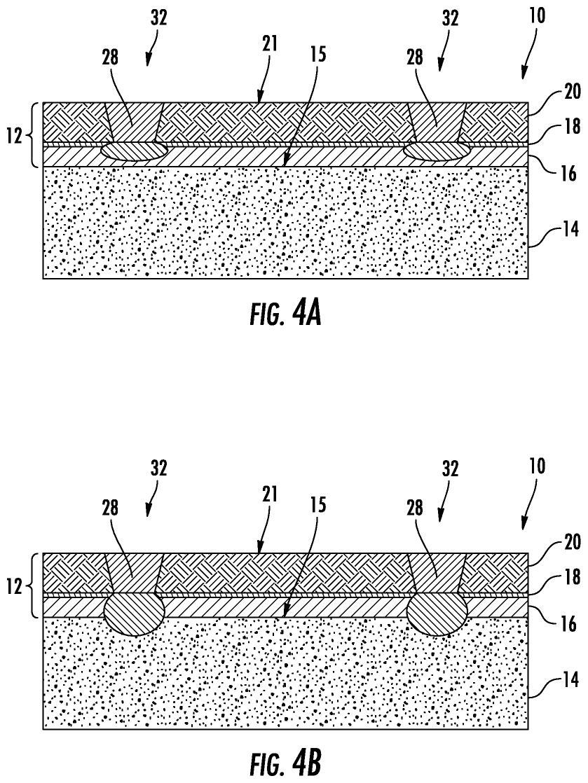

After drying, the dried first patch layer 24 and the dried second patch layer 26 may then be sintered to form the multilayered patch 28 as shown in FIGS. 4A and 4B. In embodiments, the sintering is carried out by heat treatment in an oxidizing atmosphere at a sintering temperature greater than 950° C. In embodiments, the sintering may be carried out by operating the turbine, thereby bringing the dried patch material to a temperature high enough to sinter. In embodiments, the sintering includes heating at a sintering temperature between 1000° C. and 1400° C. for at least 1 minute. In embodiments, the method includes sintering at a temperature greater than 1150° C. and less than 1375° C. for a duration of 2 hours to 48 hours.

In embodiments, the dried patch layers 24, 26 may each be subjected to an optional binder removal before the above-mentioned sintering. Binder removal may be carried out by a slow and/or step-wise heating of the dried patch material to a temperature less than 800° C. in an oxidizing atmosphere, such as air. A slow and/or step-wise heating of the dried patch layers 24, 26 may help to dissociate any bound fluid and to burn out the binder without generating excessive gas pressures that may degrade the integrity of the dried and sintered patch materials.

In embodiments, sintering may carried out in an oxidizing atmosphere. The oxidizing atmosphere includes ambient air. In embodiments, the oxidizing atmosphere during sintering includes combustion gases that may be present around the component 10 during operation.

The binder removal and sintering may be affected in a separate heating step or during the first operation of the component 10. Binder removal and sintering may be affected using a conventional furnace or by using methods such as, for example, microwave, laser, combustion torch, plasma torch, and infrared heating. In embodiments, sintering may be accomplished by heating the dried patch layers 24, 26 at a rate from 1° C./min to 500° C./min to a temperature in a range from 1150° C. to 1400° C. and holding at that temperature for up to 48 hours. In embodiments, sintering may be accomplished by heating the dried patch layers 24, 26 at a rate from 5° C./min to 10° C./min to a temperature in a range from 1200° C. to 1375° C. and holding at that temperature for up to 48 hours.

In one embodiment, sintering may densify the dried first patch layer 24 and the dried second patch layer 26. For example, the dried second patch layer 26 may be densified to form a sintered multilayer patch with a sintered first patch portion (corresponding to the dried first patch layer 24) and a sintered second patch portion (corresponding to the dried second patch layer 26).

In embodiments, the drying of the patch slurries and sintering of the dried patch layers may be achieved to repair the component 10 in situ. For example, the patch layers formed by the patch slurries may be dried at the ambient temperatures and sintered during the first high temperature operation of the component 10.

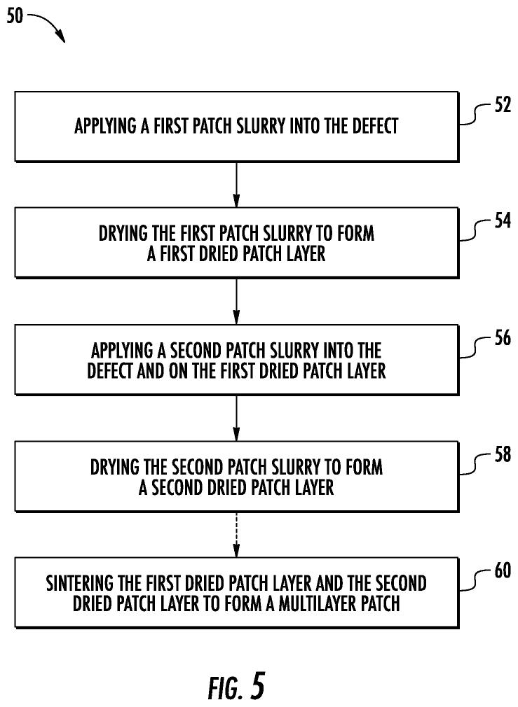

Referring to FIG. 5, a method 50 is generally shown for repairing a defect in a multilayered coating on a silicon-containing substrate, such as described above. At 52, a first patch slurry is applied into the defect. For example, when the defect extends through an environmental barrier coating and into a bond coat (e.g., a silicon bond coat) or the silicon-containing substrate, the first patch slurry comprises a first patch material of a silicon-containing material. At 54, the first patch slurry is dried to form a dried first patch layer. At 56, a second patch slurry is applied into the defect and on the dried first patch layer. Generally, the second patch slurry includes a second patch material configured to correlate with the environmental barrier coating. At 58, the second patch slurry is dried to form a second dried patch layer. At 60, the dried first patch layer and the second dried patch layer are sintered together to form a multilayer patch.

Further aspects are provided by the subject matter of the following clauses:

1. A method for repairing a defect in a multilayered coating on a silicon-containing substrate, wherein the defect extends through an environmental barrier coating and into a bond coat or the silicon-containing substrate, the method comprising: applying a first patch slurry into the defect, wherein the first patch slurry comprises a first patch material comprising a silicon-containing material, wherein the bond coat comprises silicon; drying the first patch slurry to form a dried first patch layer; applying a second patch slurry into the defect and on the dried first patch layer, wherein the second patch slurry comprises a second patch material configured to correlate with the environmental barrier coating; and drying the second patch slurry to form a second dried patch layer.

2. The method of any preceding clause, further comprising: sintering the dried first patch layer and the second dried patch layer to form a sintered multilayer patch with a sintered first patch portion and a sintered second patch portion, wherein the sintered first patch portion bonds with silicon within the bond coat, and wherein the sintered second patch portion bonds with the environmental barrier coating and/or the sintered first patch portion.

3. The method of any preceding clause, wherein the substrate is part of a gas turbine engine, and the sintering is carried out in situ by operation of the gas turbine engine.

4. The method of any preceding clause, wherein the sintering is conducted under an oxidizing atmosphere.

5. The method of any preceding clause, wherein the first patch slurry comprising a silicon-containing powder.

6. The method of any preceding clause, wherein the silicon-containing powder is substantially free from carbon and nitrogen.

7. The method of any preceding clause, wherein the first patch slurry comprises the silicon-containing material and boron.

8. The method of any preceding clause, wherein the silicon-containing powder comprises elemental silicon.

9. The method of any preceding clause, wherein the silicon-containing powder comprises: a plurality of small particles having a median particle size of less than 1 μm, a plurality of medium particles having a median particle size from 1 μm to 8 μm; and a plurality of large particles having a median particle size of greater than 8 μm.

10. The method of any preceding clause, wherein the plurality of small particles is present in an amount of 10 volume % to 50 volume % of the total volume of the silicon-containing material, the plurality of medium particles is present in an amount of 10 volume % to 50 volume % of the total volume of the silicon-containing material, and the plurality of large particles is present in an amount of 20 volume % to 60 volume % of the total volume of the silicon-containing material.

11. The method of any preceding clause, wherein the second patch slurry comprise a sintering aid, wherein the sintering aid is present in the second patch slurry in an amount of 0.4 wt % to 2.0 wt %.

12. The method of any preceding clause, wherein the first patch slurry, the second patch slurry, or both comprise a binder, wherein the binder is present in the first patch slurry or the second slurry in an amount of 2.0 wt % to 9 wt % of the dry powder mass.

13. The method of any preceding clause, wherein the first patch slurry includes the first patch material in an amount of 10 volume % to 60 volume % within a liquid carrier.

14. The method of any preceding clause, wherein the second patch slurry includes the second patch material in an amount of 10 volume % to 60 volume % within a liquid carrier.

15. The method of any preceding clause, wherein the second patch slurry comprises a zirconium silicate, a hafnium silicate, an aluminum silicate, or combinations thereof.

16. The method of any preceding clause, wherein the second patch slurry comprises a rare earth element silicate powder.

17. The method of any preceding clause, wherein the rare earth element silicate powder includes a rare earth element having a cation radius of less than 0.95 Angstroms.

18. The method of any preceding clause, wherein the rare earth element silicate powder comprises a rare earth monosilicate, a rare earth disilicate, or a combination thereof.

19. The method of any preceding clause, wherein the second patch slurry comprises a Yb₂Si₂O₇ powder.

20. A repaired multilayer coated of a silicon-containing substrate, comprising: a bond coat comprising silicon on a surface of the silicon-containing substrate; an environmental barrier coating on the silicon-containing substrate, wherein a defect extends through the environmental barrier coating and into the bond coat; a first patch within the defect of the bond coat, wherein the densified first patch comprises a first patch material comprising a silicon-based material; and a second patch within the defect of the environmental barrier coating, wherein the densified second patch comprises a second patch material configured to correlate with the environmental barrier coating.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for repairing a defect in a multilayered coating on a silicon-containing substrate, wherein the defect extends through an environmental barrier coating and into a bond coat or the silicon-containing substrate, the method comprising:
applying a first patch slurry into the defect, wherein the first patch slurry comprises a first patch material comprising a silicon-containing material, wherein the bond coat comprises silicon;
drying the first patch slurry to form a dried first patch layer;
applying a second patch slurry into the defect and on the dried first patch layer, wherein the second patch slurry comprises a second patch material that correlates with a first layer of the environmental barrier coating;
drying the second patch slurry to form a second dried patch layer;
applying a third patch slurry into the defect and on the dried second patch layer, wherein the third patch slurry comprises a third patch material that correlates with a second layer of the environmental barrier coating that includes a different material than the first layer of the environmental barrier coating; and
drying the third patch slurry to form a dried third patch layer.

2. The method of claim 1, further comprising:
sintering the dried first patch layer and the dried second patch layer to form a sintered multilayer patch with a sintered first patch portion and a sintered second patch portion, wherein the sintered first patch portion bonds with silicon within the bond coat, and wherein the sintered second patch portion bonds with the environmental barrier coating, the sintered first patch portion, or both.

3. The method of claim 2, wherein the silicon-containing substrate is part of a gas turbine engine, and the sintering is carried out in situ by operation of the gas turbine engine.

4. The method of claim 2, wherein the sintering is conducted under an oxidizing atmosphere.

5. The method of claim 1, wherein the first patch slurry comprises a silicon-containing powder.

6. The method of claim 5, wherein the silicon-containing powder is substantially free from carbon and nitrogen.

7. The method of claim 5, wherein the first patch slurry comprises the silicon-containing material and boron.

8. The method of claim 5, wherein the silicon-containing powder comprises elemental silicon.

9. The method of claim 5, wherein the silicon-containing powder comprises: a plurality of small particles having a median particle size of less than 1 μm, a plurality of medium particles having a median particle size from 1 μm to 8 μm; and a plurality of large particles having a median particle size of greater than 8 μm.

10. The method of claim 9, wherein the plurality of small particles is present in an amount of 10 volume % to 50 volume % of a total volume of the silicon-containing material, the plurality of medium particles is present in an amount of 10 volume % to 50 volume % of the total volume of the silicon-containing material, and the plurality of large particles is present in an amount of 20 volume % to 60 volume % of the total volume of the silicon-containing material.

11. The method of claim 1, wherein the second patch slurry comprises a sintering aid, wherein the sintering aid is present in the second patch slurry in an amount of 0.4 wt % to 2.0 wt %.

12. The method of claim 1, wherein the first patch slurry, the second patch slurry, or both comprise a binder, wherein the binder is present in the first patch slurry or the second patch slurry in an amount of 2.0 wt % to 9 wt % of a dry powder mass of the first patch slurry or the second patch slurry, respectively.

13. The method of claim 1, wherein the first patch slurry includes the first patch material in an amount of 10 volume % to 60 volume % within a liquid carrier.

14. The method of claim 1, wherein the second patch slurry includes the second patch material in an amount of 10 volume % to 60 volume % within a liquid carrier.

15. The method of claim 1, wherein the second patch slurry, the third patch slurry, or both comprise a zirconium silicate, a hafnium silicate, an aluminum silicate, or combinations thereof.

16. The method of claim 1, wherein the second patch slurry, the third patch slurry, or both comprise a rare earth element silicate powder.

17. The method of claim 16, wherein the rare earth element silicate powder comprises a rare earth element having a cation radius of less than 0.95 Angstroms.

18. The method of claim 16, wherein the rare earth element silicate powder comprises a rare earth monosilicate, a rare earth disilicate, or a combination thereof.

19. The method of claim 1, wherein the second patch slurry, the third patch slurry, or both comprise a Yb₂Si₂O₇ powder.

20. A repaired multilayer coated silicon-containing substrate, comprising:
a bond coat comprising silicon on a surface of the silicon-containing substrate;
an environmental barrier coating on the silicon-containing substrate, wherein a defect extends through the environmental barrier coating and into the bond coat;
a densified first patch within the defect of the bond coat, wherein the densified first patch comprises a first patch material comprising a silicon-based material; and
a densified second patch within the defect of the environmental barrier coating, wherein the densified second patch comprises a second patch material that correlates with the environmental barrier coating.
